(19) United States
(12) Patent Application Publication
(10) Pub. No.: US 2017/0137559 A1
(43) Pub. Date: May 18, 2017

(54) TRANSPARENT AND ABRASION RESISTANT POLYURETHANE ELASTOMER AND PROCESS FOR PREPARING SAME

(71) Applicant: Covestro Deutchland AG, Monheim am Rhein (DE)

(72) Inventors: John Zhang, Pudong, Shanghai (CN); Jianfeng Xu, Pudong, Shanghai (CN); Zhong Cao, Xuhui District, Shanghai (CN)

(21) Appl. No.: 15/129,632

(22) PCT Filed: Mar. 26, 2015
(86) PCT No.: PCT/EP2015/056621

§ 371 Date: Sep. 27, 2016

(30) Foreign Application Priority Data
Mar. 31, 2014 (CN) CN201410137932.0

(51) Int. Cl. C08G 18/69; C08G 18/66; C08G 18/20; C08G 18/72

(52) U.S. Cl. CPC C08G 18/698; C08G 18/72; C08G 18/664; C08G 18/2081; C08G 2120/00

(57) ABSTRACT

The present invention relates to a transparent and abrasion resistant polyurethane elastomer prepared from a polyurethane composition under a mold pressure of 1-5 ton, wherein the polyurethane composition comprises: a) an isocyanate component comprising one or more organic polyisocyanates; b) an isocyanate-reactive component comprising: b1) polyester polyol, polyether polyol or a combination thereof; b2) one or more aliphatic diols having a molecular weight of less than 200 and an amount of 0.1-3.5 wt. %, based on 100 wt. % by weight of the isocyanate-reactive component; c) a polydiene, which is prepared by homopolymerization or copolymerization of aliphatic diene having 4-10 carbon atoms.

### FIELD OF THE INVENTION

The invention relates to a transparent and abrasion resistant polyurethane elastomer, particularly to a polyurethane elastomer prepared from a polyurethane composition comprising an isocyanate, a polyether or polyester polyol, an aliphatic diol and a polydiene under a mold pressure of 1-5 ton. The invention further relates to a process for preparing the polyurethane elastomer under a mold pressure of 1-5 ton.

### BACKGROUND OF THE INVENTION

Polyurethane is a material having wide applications due to its superior physical and mechanical properties as well as good processability. For example, polyurethane elastomer is usually used to make shoes, rubber rollers, soft parts in a vehicle, etc., as it has favorable tensile strength, tear strength and flex resistance.

In the footwear industry, a highly transparent sole material is needed for the sake of aesthetics, and yet it shall have good wear resistance. In addition, a polyurethane sole formulation is required to complete reaction in a mold rapidly and be demolded within 90 seconds in order to promote production efficiency.

Up to now, polyurethane elastomer is principally prepared by reacting an isocyanate compound with an active hydrogen-containing compound (e.g. polyester polyol or polyether polyol) in the presence of a catalyst. A conventional technical measure for increasing wear resistance of polyurethane elastomer is addition of an aid capable of improving wear resistance, for example, silicone or wax wear-resistant agents. However, these two classes of wear-resistant agents affect the transparency of polyurethane elastomer to such an extent that a polyurethane elastomer material having both wearing resistance and transparency can not be obtained.

CN102190755A discloses addition of polybutadiene in the preparation of polyurethane elastomer to improve the wear resistance of the polyurethane elastomer. CN102344541A discloses a polyurethane having improved wear resistance, wherein an amount of polyisoprene is included in the reaction components of the polyurethane.

Considerably high production efficiency is sought in the footwear industry. Accordingly, the polyurethane elastomer system is required to have high reactivity. However, high reactivity leads to difficulty in escape of the gas generated in the reaction. The gas is embedded in the polyurethane elastomer, the transparency of which is thus affected.

Mold pressure has a great impact on the transparency of polyurethane elastomer too. High mold pressure is favorable to the transparency of polyurethane elastomer. Generally, an ideal polyurethane elastomer exhibiting high reactivity and transparency can only be obtained under a mold pressure higher than 7 ton. The mold pressure of the existing facilities for producing polyurethane elastomer in the footwear industry is mostly about 3-5 ton which is undesirable for producing highly transparent polyurethane elastomer.

Therefore, there is a need in the footwear industry for a polyurethane elastomer which can be prepared by a rapid reaction in an equipment having a mold pressure of 1-5 ton and which has high transparency and good wear resistance.

### BRIEF SUMMARY OF THE INVENTION

In one aspect of the invention, there is provided a transparent and abrasion resistant polyurethane elastomer prepared from a polyurethane composition under a mold pressure of 1-5 ton, wherein the polyurethane composition comprises:

a) an isocyanate component comprising one or more organic polyisocyanates;

b) an isocyanate-reactive component comprising:
b1) polyester polyol, polyether polyol or a combination thereof;
b2) one or more aliphatic diols having a molecular weight of less than 200 and an amount of 0.1-3.5 wt. %, based on 100 wt. % by weight of the isocyanate-reactive component;

c) a polydiene, which is prepared by homopolymerization or copolymerization of aliphatic diene having 4-10 carbon atoms.

In an embodiment of the invention, b1) is selected from polyester polyols having a molecular weight of 1000-3000 and a functionality of 1.9-3.0, preferably polyester polyols having a molecular weight of 1000-3000 and a functionality of 1.9-2.1.

In another embodiment of the invention, the aliphatic diol is selected from the group consisting of ethylene glycol, diethylene glycol, 1,2-propanediol, 1,3-propanediol, 1,3-butanediol, 1,4-butanediol or combinations thereof.

In still another embodiment of the invention, the polydiene is selected from the group consisting of polybutadiene, polyisoprene or a combination thereof. Preferably, the polybutadiene has a content of 1,2-vinyl of less than 30 wt. %, based on 100 wt. % by weight of the polybutadiene.

In yet another embodiment of the invention, the polydiene has an amount of 0.5-6.0 wt. %, based on 100 wt. % by weight of the isocyanate-reactive component.

In yet another embodiment of the invention, the polyurethane composition has a gel time of less than 15 seconds.

In another aspect of the invention, there is provided a process of preparing a transparent and abrasion resistant polyurethane elastomer, comprising: preparing the polyurethane elastomer from a polyurethane composition under a mold pressure of 1-5 ton, wherein the polyurethane composition comprises:

a) an isocyanate component comprising one or more organic polyisocyanates;

b) an isocyanate-reactive component comprising:
b1) polyester polyol, polyether polyol or a combination thereof;
b2) one or more aliphatic diols having a molecular weight of less than 200 and an amount of 0.1-3.5 wt. %, based on 100 wt. % by weight of the isocyanate-reactive component;

c) a polydiene, which is prepared by homopolymerization or copolymerization of aliphatic diene having 4-10 carbon atoms.

In an embodiment of the invention, b1) is selected from polyester polyols having a molecular weight of 1000-3000 and a functionality of 1.9-3.0, preferably polyester polyols having a molecular weight of 1000-3000 and a functionality of 1.9-2.1.

In another embodiment of the invention, the aliphatic diol is selected from the group consisting of ethylene glycol, diethylene glycol, 1,2-propanediol, 1,3-propanediol, 1,3-butanediol, 1,4-butanediol or combinations thereof.

In still another embodiment of the invention, the polydiene is selected from the group consisting of polybutadiene, polyisoprene or a combination thereof. Preferably, the polybutadiene has a content of 1,2-vinyl of less than 30 wt. %, based on 100 wt. % by weight of the polybutadiene.

In yet another embodiment of the invention, the polydiene has an amount of 0.5-6.0 wt. %, based on 100 wt. % by weight of the isocyanate-reactive component.

In yet another embodiment of the invention, the polyurethane composition has a gel time of less than 15 seconds.

### DETAILED DESCRIPTION OF THE INVENTION

I. Polyurethane Elastomer

In one aspect of the invention, there is provided a transparent and abrasion resistant polyurethane elastomer. The polyurethane elastomer provided according to the invention can be prepared under a mold pressure of 1-5 ton, and has good transparency and wear resistance, as well as desirable physical and mechanical properties. The polyurethane elastomer is prepared from a polyurethane composition under a mold pressure of 1-5 ton, wherein the polyurethane composition comprises:

a) an isocyanate component comprising one or more organic polyisocyanates;

b) an isocyanate-reactive component comprising:
b1) polyester polyol, polyether polyol or a combination thereof;
b2) one or more aliphatic diols having a molecular weight of less than 200 and an amount of 0.1-3.5 wt. %, based on 100 wt. % by weight of the isocyanate-reactive component;

c) a polydiene, which is prepared by homopolymerization or copolymerization of aliphatic diene having 4-10 carbon atoms.

The organic polyisocyanate in component a) is represented by the following general formula:

R(NCO)ₙ

wherein n is 2-4, preferably 2; R represents an aliphatic hydrocarbyl having 2-18 carbon atoms, cycloaliphatic hydrocarbyl having 3-18 carbon atoms, aromatic hydrocarbyl having 6-15 carbon atoms, or araliphatic hydrocarbyl having 8-15 carbon atoms.

Specific examples include but are not limited to ethylene diisocyanate, tetramethylene diisocyanate, hexamethylene diisocyanate (HDI), 1,12-dodecylene diisocyanate, cyclobutane-1,3-diisocyanate, cyclohexane-1,3-diisocyanate, cyclohexane-1,4-diisocyanate, a mixture of cyclohexane-1,3-diisocyanate and cyclohexane-1,4-diisocyanate, 1-isocyanato-3,3,5-trimethyl-5-isocyanatomethylcyclohexane, hexahydrotoluene-2,4-diisocyanate, hexahydrotoluene-2,6-diisocyanate, a mixture of hexahydrotoluene-2,4-diisocyanate and hexahydrotoluene-2,6-diisocyanate, 1,3-hexahydrophenylene diisocyanate, 1,4-hexahydrophenylene diisocyanate, perhydrodiphenylmethane 2,4-diisocyanate, perhydrodiphenylmethane-4,4 ‘-diisocyanate, 1,3-phenylene diisocyanate, 1,4-phenylene diisocyanate, 1,4-durene diisocyanate, 1,2-diphenylethene-4,4’-diisocyanate, 3,3′-dimethyl-4,4′-diphenylene diisocyanate, toluene 2,4-diisocyanate, toluene 2,6-diisocyanate (TDI), a mixture of toluene 2,4-diisocyanate and toluene 2,6-diisocyanate, diphenylmethane-2,4′-diisocyanate, diphenylmethane-2,2′-diisocyanate, diphenylmethane-4,4′-diisocyanate (MDI), and naphthalene-1,5-diisocyanate (NDI).

The organic isocyanate may also be a modified organic polyisocyanate which includes the above isocyanates comprising a structure selected from carbodiimide, uretoneimine, allophanate, or isocyanurate.

The organic polyisocyanate may also be a polyisocyanate prepolymer. The polyisocyanate prepolymer has a NCO content of preferably but not limited to 5-30 wt. %, more preferably 10-25 wt. %, based on 100 wt. % by weight of the organic polyisocyanate prepolymer.

The polyurethane composition of the invention further comprises an isocyanate-reactive component b) comprising b1) polyester polyol, polyether polyol or a combination thereof.

The polyether polyol may be prepared by a known process, for example, by reacting an olefin oxide with a starter in the presence of a catalyst. The catalyst is preferably but not limited to an alkaline hydroxide, an alkaline alkoxide, antimony pentachloride, boron trifluoride-diethyl etherate, a double metal cyanide or a combination thereof. The olefin oxide is preferably but not limited to tetrahydrofuran, ethylene oxide, 1,2-propylene oxide, 1,2-butylene oxide, 2,3-butylene oxide, styrene oxide, or a combination thereof. The starter is preferably but not limited to a polyhydroxy compound which is preferably but not limited to water, ethylene glycol, 1,2-propanediol, 1,3-propanediol, diethylene glycol, trimethylolpropane or a combination thereof. The polyether polyol has a functionality of 2-8, preferably 2-6, more preferably 2-4, and a number average molecular weight of 500-8000, preferably 800-3500. A poly(propylene oxide-ethylene oxide) polyol is preferably used.

The polyester polyol is prepared by the reaction between a dibasic carboxylic acid or a dibasic carboxylic anhydride and a polyol. The dibasic carboxylic acid is preferably but not limited to an aliphatic carboxylic acid having 2-12 carbons, preferably but not limited to succinic acid, malonic acid, glutaric acid, adipic acid, suberic acid, azelaic acid, sebacic acid, dodecanoic acid, maleic acid, fumaric acid, phthalic acid, isophthalic acid, terephthalic acid, or a combination thereof. The dibasic carboxylic anhydride is preferably but not limited to phthalic anhydride, tetrachlorophthalic anhydride, maleic anhydride or a combination thereof. The polyol is preferably but not limited to ethylene glycol, diethylene glycol, 1,2-propanediol, 1,3-propanediol, dipropylene glycol, 1,3-methylpropanediol, 1,4-butanediol, 1,5-pentanediol, 1,6-hexanediol, neopentanediol, 1,10-decanediol, glycerine, trimethylolpropane, or a combination thereof. The polyester polyol also includes a polyester polyol prepared from a lactone. The polyester polyol prepared from a lactone is preferably but not limited to ε-caprolactone. In the preferred embodiments of the invention, the polyester polyol is selected from polyester polyols having a molecular weight of 1000-3000 and a functionality of 1.9-3.0, preferably 1.9-2.1.

The isocyanate-reactive component b) may also comprise other high molecular polyols commonly used for preparing polyurethane elastomer, including but not limited to polycarbonate diols and polymer polyols.

The polycarbonate diol may be prepared by reacting a diol with a dihydrocarbyl carbonate or a diaryl carbonate or phosgene. The diol is preferably but not limited to 1,2-propanediol, 1,3-propanediol, 1,4-butanediol, 1,5-pentanediol, 1,6-hexanediol, diethylene glycol, trioxymethylene diol or a mixture thereof. The dihydrocarbyl carbonate or diaryl carbonate is preferably but not limited to diphenyl carbonate, dimethyl carbonate, diethyl carbonate or a mixture thereof. The polycarbonate diol may be selected from polyestercarbonate diols, polyethercarbonate diols or combinations thereof. The polyestercarbonate diol may be selected from but not limited to aliphatic polycarbonate diols. The polyestercarbonate diol may be prepared by reacting a diaryl or dialkyl diol comprising an ester group with phosgene. The diol comprising an ester group may be obtained by ring-opening esterification between ε-caprolactone and a diol, or by the reaction between a dicarboxylic acid or a derivative thereof and a diol. The polyethercarbonate diol may be obtained by reaction between an olefin oxide, preferably propylene oxide with carbon dioxide in the presence of a suitable catalyst.

The polymer polyol is preferably but not limited to a polymer polyester polyol, a polymer polyether polyol or a mixture thereof.

The polymer polyester polyol is a polymer modified polyester polyol, preferably a grafted polyester polyol, or a polyester polyol dispersion. The grafted polyester polyol is preferably a styrene and/or acrylonitrile based grafted polyester polyol, wherein the styrene and/or acrylonitrile may be obtained by in situ polymerization of styrene, acrylonitrile, or a mixture of styrene and acrylonitrile; wherein the ratio of styrene to acrylonitrile in the mixture of styrene and acrylonitrile is 90:10-10:90, preferably 70:30-30:70. The polymer polyester polyol dispersion comprises a dispersion phase, e.g. an inorganic filler, a polyurea, a polyhydrazide, or a polyurethane comprising a bonded tertiary amino group and/or melamine. The dispersion phase has an amount of 1-50 wt. %, preferably 1-45 wt. %, based on 100 wt. % by weight of the polymer polyester polyol.

The polymer polyether polyol is a polymer modified polyether polyol, preferably a grafted polyether polyol, or a polyether polyol dispersion. The grafted polyether polyol is preferably a styrene and/or acrylonitrile based grafted polyether polyol, wherein the styrene and/or acrylonitrile may be obtained by in situ polymerization of styrene, acrylonitrile, or a mixture of styrene and acrylonitrile; wherein the ratio of styrene to acrylonitrile in the mixture of styrene and acrylonitrile is 90:10-10:90, preferably 70:30-30:70. The polymer polyether polyol dispersion comprises a dispersion phase, e.g. an inorganic filler, a polyurea, a polyhydrazide, or a polyurethane comprising a bonded tertiary amino group and/or melamine. The dispersion phase has an amount of 1-50 wt. %, preferably 1-45 wt. %, based on 100 wt. % by weight of the polymer polyether polyol.

The polyurethane composition of the invention further comprises b2) one or more aliphatic diols having a molecular weight of less than 200 and an amount of 0.1-3.5 wt. %, based on 100 wt. % by weight of the isocyanate-reactive component. Examples of aliphatic diols suitable for the invention include: ethylene glycol, 1,2- and 1,3-propanediol, 1,3-, 1,4- and 2,3-butanediol, 1,6-hexanediol, 1,8-octanediol, 1,10-decanediol, neopentanediol, 1,3- and 1,4-di(methylol)cyclohexane, 2-methyl-1,3-propanediol, diethylene glycol, triethylene glycol, tripropylene glycol, dibutylene glycol, N-methyl-diethanolamine, cyclohexane dimethanol and 2-methyl-1,3-propanediol. In the embodiments of the invention, the aliphatic diol is preferably selected from the group consisting of ethylene glycol, diethylene glycol, 1,2-propanediol, 1,3-propanediol, 1,3-butanediol, 1,4-butanediol, or combinations thereof, more preferably ethylene glycol.

The polyurethane composition of the invention further comprises a polydiene which is prepared by homopolymerization or copolymerization of aliphatic diene monomer having 4-10 carbon atoms. In the embodiments of the invention, the polydiene has an amount of 0.5-6.0 wt. %, based on 100 wt. % by weight of the isocyanate-reactive component. In the embodiments of the invention, the aliphatic diene monomer may be selected from but not limited to the group consisting of 1,3-butadiene, 1,3-pentadiene, 2-methyl-1,3-butadiene (isoprene), 2,3-dimethyl butadiene, 2-ethyl-1,3-butadiene, 2-n-propyl-1,3-butadiene, 2-tert-butyl-1,3-butadiene or combinations thereof, preferably from 1,3-butadiene, isoprene and a combination thereof. In some other embodiments of the invention, the polydiene is selected from the group consisting of polybutadiene, polyisoprene and a combination thereof. In still some other embodiments of the invention, the polydiene is selected from polybutadiene which preferably has a content of 1,2-vinyl of less than 30 wt. %, based on 100 wt. % by weight of the polybutadiene.

In some embodiments of the invention, the polyurethane composition has a gel time of less than 15 seconds. One skilled in the art knows the methods for adjusting the gel time of a polyurethane composition. For example, the amount of the catalyst may be adjusted to control the reaction rate, so that the gel time is regulated. The polyurethane composition of the invention has a short gel time and a rapid reaction rate. Nevertheless, a polyurethane elastomer having superior transparency can still be obtained easily.

As used herein, “gel time” means the period of time from the point when a polyurethane composition is mixed to the point when a fiber string can be pulled out from the polyurethane composition, also referred to as fiber time or string time.

One skilled in the art may use a blowing agent, a catalyst, a surfactant, a pigment, a filler or other appropriate additives as desired in preparation of the polyurethane elastomer material of the invention.

The blowing agent used in the invention may be selected from various physical or chemical blowing agents, preferably but not limited to water, halogenated hydrocarbons, hydrocarbon compounds, and gases. The halogenated hydrocarbons are preferably but not limited to chlorodifluoromethane, dichloromonofluoromethane, dichlorofluoromethane, trichlorofluoromethane, or mixtures thereof. The hydrocarbon compounds are preferably but not limited to butane, pentane, cyclopentane, hexane, cyclohexane, heptane, or mixtures thereof. The gases are preferably but not limited to air, CO₂ or N₂. In particular, the blowing agent is preferably water. The amount of the blowing agent used depends on the desired density of the polyurethane.

The catalyst used in the invention is preferably but not limited to an amine catalyst, an organometallic catalyst or a mixture thereof. The amine catalyst is preferably but not limited to triethylamine, tributylamine, triethylenediamine, N-ethylmorpholine, N,N,N′,N′-tetramethylethylenediamine, pentamethyldiethylenetriamine, N-methylaniline, N,N-dimethylaniline, or a mixture thereof. The organometallic catalyst is preferably but not limited to an organotin compound, e.g. tin (II) acetate, tin (II) octanoate, tin ethylhexanoate, tin laurate, dibutyl tin oxide, dibutyl tin dichloride, dibutyl tin diacetate, dibutyl tin maleate, dioctyl tin diacetate, or a mixture thereof. The amount of the catalyst used is 0.001-10 wt. %, based on 100 wt. % by weight of the sum of the polyols used in the reaction system.

The surfactant used in the invention is preferably but not limited to an ethylene oxide derivative of a siloxane. The amount of the catalyst used is 0.01-8 wt. %, based on 100 wt. % by weight of the sum of the polyols and the chain extender used in the reaction system.

The pigment and/or filler used in the invention are preferably but not limited to calcium carbonate, graphite, carbon black, titanium dioxide, iron oxide, alumina trihydrate, wollastonite, glass fiber, polyester fiber, and polymer fiber.

II. Process of Preparing Polyurethane Elastomer

The polyurethane elastomer of the invention may be prepared as follows: mixing the above components at 20-80° C., preferably 30-60° C., optionally in the presence of a catalyst, a blowing agent and a surfactant; injecting the composition into an open or closed mold; clamping the mold under a mold pressure of 1-5 ton; and demolding after 1-1.5 min to obtain the polyurethane product. Particular details can be found in Kunststoff Handbuch, Volume VII, Polyurethane, 1994, Dr. G. Oertel, Carl-Hanser-Verlag, Munich. The mold may be any one commonly used in the prior art for preparing polyurethane elastomer. The above polyurethane composition may be allowed to react in the mold to produce the polyurethane product provided by the invention.

The mold pressure (also referred to as locking pressure) of an injection molding machine refers to the maximum force for clamping a cavity body for an article, wherein the cavity body is formed by combining two (or more) mold pieces in a mold device. Owing to the action of this mold pressure, the mold will not be opened by an injection force of a molten material when the molten material is fed into the mold cavity at a certain injection force and a certain flow rate.

In the invention, the minimum mold pressure (i.e. a mold pressure that prevents a molten material from opening the mold) needed for injection molding a plastic article meets the following relationship:

F≧KPA

wherein F is the mold pressure in ton; K is a safety factor, generally K=1-1.2; P is the pressure in a mold cavity in MPa, which is the average pressure in the mold cavity as determined experimentally in the invention; and A is the area of the contour of an article projecting on the parting surface of the mold, in cm².

The isocyanate index of the reaction may be optimized by a method well known in the art.

The isocyanate index of the reaction is preferably but not limited to 50-160, more preferably 80-120.

### EXAMPLES

The specific examples and procedures disclosed herein are intended to be exemplary, rather than limiting.

The starting materials mentioned in context are described as follows:

Bayflex FW30FX101: a polyester polyol, average molecular weight 2000, hydroxyl number 56 mg KOH/g, available from Bayer Material Science Corporate;

Dabco EG: an amine catalyst, available from Air Products and Chemicals Inc.;

DC200: a silicone wear-resistant agent, available from Dow Corning Co.;

LBR 307: polybutadiene, molecular weight 8000, available from Kuraray Co., Japan;

LIR 30: polyisoprene, molecular weight 28000, available from Kuraray Co., Japan;

Desmodur 0928: polyisocyanate, isocyanate content 16.3%, available from Bayer Material Science Corporate;

Pura 17069: a release agent, available from Chem-Trend Co.

The reaction components Bayflex FW30FX101, ethylene glycol, polybutadiene or polyisoprene were blended homogeneously with the aid of an agitator to formulate a mixture. The resulting mixture and Desmodur 0928 were mixed in a DESMA low-pressure reaction molding machine, and then injected into a mold coated with the release agent Pura 17069. The mold was clamped under a mold pressure of 3 ton, wherein the temperature of the mold was 50° C. After 90 seconds, demolding was conducted to obtain the polyurethane elastomer.

Test Methods

Transparency: the polyurethane elastomer material prepared is observed with naked eyes, and it is scored:
3 if completely transparent;
2 if slightly nebulous, but still transparent; or
1 if completely opaque.

Wear resistance: tested according to the DIN 53516 method;

Gel time (GT): the time, in second, when a string can be pulled out with a bamboo stick which is stuck into the polyurethane elastomer under reaction and pulled back;

Pull time (PT): the time, in second, when the polyurethane elastomer can not be torn apart by hand.

TABLE 1
Polyurethane compositions and properties of the
polyurethane elastomers prepared therefrom

| | C1 | C2 | E1 | E2 | E3 | E4 |
|---|---|---|---|---|---|---|
| Bayflex | 100 | 100 | 100 | 100 | 100 | 100 |
| FW30FX101 | | | | | | |
| Dabco EG | 2 | 2 | 2 | 2 | 2 | 2 |
| Ethylene | 2 | 4 | 2 | — | 0.1 | 3.0 |
| glycol | | | | | | |
| LBR307 | — | 3 | 3 | — | 3 | 3 |
| LIR30 | — | — | — | 3 | — | — |
| DC200 | 1.5 | — | — | — | — | — |
| Desmodur | Isocya- | Isocya- | Isocya- | Isocya- | Isocya- | Isocya- |
| 0928 | nate | nate | nate | nate | nate | nate |
| | index | index | index | index | index | index |
| | 96 | 96 | 96 | 96 | 96 | 96 |
| Trans- | 1 | 1 | 2 | 2 | 3 | 2 |
| parency | | | | | | |
| DIN abrasion | 16 | 18 | 19 | 21 | 21 | 20 |
| loss (mm³) | | | | | | |
| Reactivity | 12/53 | 12/48 | 12/51 | 12/49 | 12/55 | 12/50 |
| (GT/PT) | | | | | | |

### Comparative Example C1

a polyurethane elastomer prepared using the silicone wear-resistant agent, having good wear resistance but undesirable transparency;

### Comparative Example C2

a polyurethane elastomer prepared using liquid polybutadiene but with 4 parts ethylene glycol (based on 100 parts polyols) in the composition, having good wear resistance but undesirable transparency;

### Example E1

a polyurethane elastomer prepared using liquid polybutadiene with 2 parts ethylene glycol (based on 100 parts polyols) in the composition, having good wear resistance and transparency;

### Example E2

a polyurethane elastomer prepared using liquid polyisoprene with 2 parts ethylene glycol (based on 100 parts polyols) in the composition, having good wear resistance and transparency;

### Example E3

a polyurethane elastomer prepared using liquid polybutadiene with 0.1 part ethylene glycol (based on 100 parts polyols) in the composition, having good wear resistance and transparency;

### Example E4

a polyurethane elastomer prepared using liquid polybutadiene with 3.0 parts ethylene glycol (based on 100 parts polyols) in the composition, having good wear resistance and transparency.

1. A transparent and abrasion resistant polyurethane elastomer prepared from a polyurethane composition under a mold pressure of 1-5 ton, wherein the polyurethane composition comprises:
a) an isocyanate component comprising one or more organic polyisocyanates;
b) an isocyanate-reactive component comprising:
b1) a polyester polyol, a polyether polyol or a combination thereof;
b2) one or more aliphatic diols having a molecular weight of less than 200 and comprising an amount of 0.1-3.5 wt. %, based on 100 wt. % by weight of the isocyanate-reactive component; and
c) a polydiene, which is prepared by homopolymerization or copolymerization of an aliphatic diene having 4-10 carbon atoms.

2. The polyurethane elastomer according to claim 1, wherein b1) comprises a polyester polyol having a molecular weight of 1000-3000 and a functionality of 1.9-3.0.

3. The polyurethane elastomer according to claim 2, wherein b1) comprises a polyester polyol having a molecular weight of 1000-3000 and a functionality of 1.9-2.1.

4. The polyurethane elastomer according to claim 1, wherein the aliphatic diol is selected from the group consisting of ethylene glycol, diethylene glycol, 1,2-propanediol, 1,3-propanediol, 1,3-butanediol, 1,4-butanediol, and combinations thereof.

5. The polyurethane elastomer according to claim 1, wherein the polydiene is selected from the group consisting of polybutadiene, polyisoprene, and a combination thereof.

6. The polyurethane elastomer according to claim 5, wherein the polydiene comprises polybutadiene, and wherein the polybutadiene has a content of 1,2-vinyl of less than 30 wt. %, based on 100 wt. % by weight of the polybutadiene.

7. The polyurethane elastomer according to claim 1, wherein the polyurethane composition comprises the polydiene in an amount of 0.5-6.0 wt. %, based on 100 wt. % by weight of the isocyanate-reactive component.

8. The polyurethane elastomer according to claim 1, wherein the polyurethane composition has a gel time of less than 15 seconds.

9. A process of preparing a transparent and abrasion resistant polyurethane elastomer, comprising:
preparing the polyurethane elastomer from a polyurethane composition under a mold pressure of 1-5 ton, wherein the polyurethane composition comprises:
a) an isocyanate component comprising one or more organic polyisocyanates;
b) an isocyanate-reactive component comprising:
b1) a polyester polyol, a polyether polyol or a combination thereof;
b2) one or more aliphatic diols having a molecular weight of less than 200 and comprising an amount of 0.1-3.5 wt. %, based on 100 wt. % by weight of the isocyanate-reactive component; and
c) a polydiene, which is prepared by homopolymerization or copolymerization of an aliphatic diene having 4-10 carbon atoms.

10. The process according to claim 9, wherein b1) comprises a polyester polyol having a molecular weight of 1000-3000 and a functionality of 1.9-3.0.

11. The process according to claim 10, wherein b1) comprises a polyester polyol having a molecular weight of 1000-3000 and a functionality of 1.9-2.1.

12. The process according to claim 9, wherein the aliphatic diol is selected from the group consisting of ethylene glycol, diethylene glycol, 1,2-propanediol, 1,3-propanediol, 1,3-butanediol, 1,4-butanediol and, combinations thereof.

13. The process according to claim 9, wherein the polydiene is selected from the group consisting of polybutadiene, polyisoprene, and a combination thereof.

14. The process according to claim 13, wherein the polydiene comprises polybutadiene, and wherein the polybutadiene has a content of 1,2-vinyl of less than 30 wt. %, based on 100 wt. % by weight of the polybutadiene.

15. The process according to claim 9, wherein the polyurethane composition comprises the polydiene in an amount of 0.5-6.0 wt. %, based on 100 wt. % by weight of the isocyanate-reactive component.

16. The process according to claim 9, wherein the polyurethane composition has a gel time of less than 15 seconds.
